(19) United States
(12) Patent Application Publication
(10) Pub. No.: US 2026/0012834 A1
(43) Pub. Date: Jan. 8, 2026

(54) MEASUREMENT METHOD AND FIRST TERMINAL

(71) Applicant: GUANGDONG OPPO MOBILE TELECOMMUNICATIONS CORP., LTD., Dongguan (CN)

(72) Inventors: Qianxi LU, Dongguan (CN); Bingxue LENG, Dongguan (CN); Yi HU, Dongguan (CN)

(21) Appl. No.: 19/325,855

(22) Filed: Sep. 11, 2025

Related U.S. Application Data
(63) Continuation of application No. PCT/CN2023/081422, filed on Mar. 14, 2023.

(51) Int. Cl. H04W 24/10; H04B 17/318; H04W 8/00; H04W 92/18

(52) U.S. Cl. CPC H04W 24/10; H04B 17/328; H04W 8/005; H04W 92/18

(57) ABSTRACT

The disclosure relates to a measurement method and a first terminal. The measurement method includes the following. A first terminal performs processing regarding measurement of an adjacent link when measurement information of a serving link meets a first criterion. The serving link is a link between the first terminal and a serving device. The adjacent link is a link between the first terminal and an adjacent device. The serving device and/or the adjacent device is a relay terminal.

### CROSS REFERENCE TO RELATED APPLICATION(S)

This application is a continuation of International Application No. PCT/CN2023/081422, filed Mar. 14, 2023, the entire disclosure of which is incorporated herein by reference.

### TECHNICAL FIELD

The disclosure relates to the field of communications, and more specifically, to a measurement method and a first terminal.

### BACKGROUND

In communication systems, a terminal in a non-connected state can perform radio resource management (RRM) measurement on a serving cell and another neighboring cell based on network configuration to support mobility operations such as cell reselection. In sidelink (SL) scenarios, the terminal can also perform RRM measurement to select an appropriate serving relay terminal or network node. How to reduce terminal power consumption needs to be considered.

### SUMMARY

Embodiments of the disclosure provide a measurement method. The method includes the following. A first terminal performs processing regarding measurement of an adjacent link when measurement information of a serving link meets a first criterion. The serving link is a link between the first terminal and a serving device. The adjacent link is a link between the first terminal and an adjacent device. The serving device and/or the adjacent device is a relay terminal.

Embodiments of the disclosure provide a measurement method. The method includes the following. A serving device transmits first indication information to a first terminal. The first indication information is used for the first terminal to determine a first criterion so as to perform processing regarding measurement of an adjacent link when measurement information of a serving link meets the first criterion. The serving link is a link between the first terminal and the serving device. The adjacent link is a link between the first terminal and an adjacent device. The serving device and/or the adjacent device is a relay terminal.

Embodiments of the disclosure provide a first terminal. The first terminal includes a processor and a memory. The memory is configured to store computer programs. The processor is configured to invoke and execute the computer programs stored in the memory, to cause the first terminal to perform the measurement method.

### BRIEF DESCRIPTION OF THE DRAWINGS

FIG. 1 is a schematic diagram of a communication system according to embodiments of the disclosure.

FIG. 2 is a schematic flowchart of a measurement method according to an embodiment of the disclosure.

FIG. 3 is a schematic flowchart of a measurement method according to another embodiment of the disclosure.

FIG. 4 is a schematic diagram of application example 1 of a measurement method according to embodiments of the disclosure.

FIG. 5 is a schematic diagram of application example 2 of a measurement method according to embodiments of the disclosure.

FIG. 6 is a schematic diagram of application example 3 of a measurement method according to embodiments of the disclosure.

FIG. 7 is a schematic structural diagram of a first terminal according to an embodiment of the disclosure.

FIG. 8 is a schematic structural diagram of a first terminal according to another embodiment of the disclosure.

FIG. 9 is a schematic structural diagram of a serving device according to an embodiment of the disclosure.

FIG. 10 is a schematic structural diagram of a serving device according to another embodiment of the disclosure.

FIG. 11 is a schematic structural diagram of a communication device according to embodiments of the disclosure.

FIG. 12 is a schematic structural diagram of a chip according to embodiments of the disclosure.

FIG. 13 is a schematic structural diagram of a communication system according to embodiments of the disclosure.

### DETAILED DESCRIPTION

The following will describe technical solutions of embodiments of the disclosure with reference to the accompanying drawings.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area networks (WLAN), a wireless fidelity (Wi-Fi), a 5th-generation (5G) system, or other communication systems.

Generally speaking, a conventional communication system generally supports a limited number of connections and therefore is easy to implement. However, with development of communication technology, a mobile communication system will not only support conventional communication but also support, for example, device to device (D2D) communication, machine to machine (M2M) communication, machine type communication (MTC), and vehicle to vehicle (V2V) communication, vehicle to everything (V2X) communication, or other terminal-to-terminal direct communication. Embodiments of the disclosure can also be applied to these communication systems.

In an implementation, a communication system in embodiments of the disclosure may be applied to a carrier aggregation (CA) scenario, a dual connectivity (DC) scenario, or a standalone (SA) network deployment scenario.

In an implementation, the communication system in embodiments of the disclosure is applicable to an unlicensed spectrum, and an unlicensed spectrum may be regarded as a shared spectrum. Or the communication system in embodiments of the disclosure is applicable to a licensed spectrum, and a licensed spectrum may be regarded as a non-shared spectrum.

Embodiments of the disclosure have been described in connection with the network device and the terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device.

The terminal device may be a station (ST or STA) in a WLAN, a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, and a next-generation communication system, for example, a terminal device in an NR network, a terminal device in a future evolved public land mobile network (PLMN), etc.

In embodiments of the disclosure, the terminal device may be deployed on land, for example, deployed indoors or outdoors, and may be handheld, wearable, or vehicle-mounted. The terminal device may also be deployed on water, for example, on a ship, etc., or under water, for example, on a submarine, etc. The terminal device may also be deployed in the air, for example, on an airplane, an air balloon, a satellite, etc.

In embodiments of the disclosure, the terminal device may be a mobile phone, a pad, a computer with a wireless transceiver function, a virtual reality (VR) terminal device, an augmented reality (AR) terminal device, a terminal device in a personal internet of things (PIOT), a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, etc.

By way of explanation rather than limitation, in embodiments of the disclosure, the terminal device may also be a wearable device. The wearable device may also be called a wearable smart device, which is a generic term of wearable devices obtained through intelligentization designing and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in the WLAN, a base transceiver station (BTS) in the GSM or CDMA, may also be a Node B (NB) in WCDMA, and may further be an evolutional Node B (eNB or eNodeB) in LTE, or a relay station or AP, or an in-vehicle device, a wearable device, a network device or a g-Node B (gNB) in the NR network, a network device in the future evolved PLMN, or a network device in the NTN network, etc.

By way of explanation rather than limitation, in embodiments of the disclosure, the network device may be of mobility. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station located on land, water, etc.

In embodiments of the disclosure, the network device can provide services for a cell, and the terminal device communicates with the network device through a transmission resource (for example, a frequency-domain resource or a spectrum resource) for the cell. The cell may be a cell corresponding to the network device (for example, a base station). The cell may correspond to a macro base station, and may correspond to a base station corresponding to a small cell. The small cell may include: a metro cell, a micro cell, a pico cell, a femto cell, and the like. These small cells are characterized by small coverage and low transmission power and are adapted to provide data transmission service with high-rate.

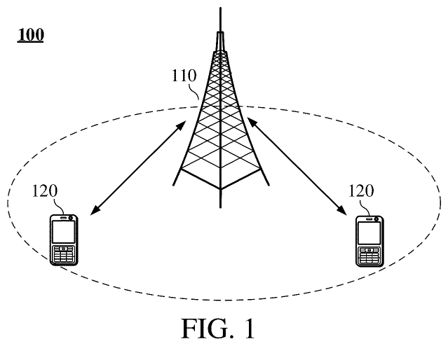

FIG. 1 exemplarily illustrates a communication system 100. The communication system includes one network device 110 and two terminal devices 120. In a possible implementation, the communication system 100 may include multiple network devices 110, there may be other numbers of terminal devices 120 in the coverage of each network device 110, and embodiments of the disclosure are not limited in this regard.

In a possible implementation, the communication system 100 may further include other network entities, such as a mobility management entity (MME) and an access and mobility management function (AMF), and embodiments of the disclosure are not limited in this regard.

It should be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

It should be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that that there is an association relationship between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In order for better understanding of technical solutions of embodiments of the disclosure, technologies related to embodiments of the disclosure will be elaborated below. The following related art as an optional scheme can be arbitrarily combined with the technical solutions of embodiments of the disclosure, which shall all belong to the protection scope of embodiments of the disclosure. Embodiments of the disclosure include at least some of the following.

At present, pursuit of people for rate, delay, high-speed mobility, and efficiency, and diversification and complication of services in the future life is driving the development and evolution of 5G technologies. 5G is mainly applied to enhanced mobile broadband (eMBB), ultra-reliable low latency communications (URLLC), and massive machine type of communication (mMTC).

NR may be deployed independently. In 5G network environment, for reduction of air interface signaling and fast recovery of wireless connections and data services, a new radio resource control (RRC) state, i.e., an RRC_INACTIVE state is defined. This state is different from an RRC_IDLE state (RRC idle state) and an RRC_CONNECTED state (RRC connected state). Specifically, the RRC state includes the following.

RRC_IDLE: Mobility is based on cell selection/reselection by the UE, paging is initiated by a core network (CN), a paging area is configured by the CN, and there is no UE access stratum (AS) context on the base station side, and there is no RRC connection.

RRC_CONNECTED: The RRC connection exists, the UE AS context exits in the base station and the UE, the network side is aware of a location of the UE at a specific cell level, the mobility is controlled on the network side, and unicast data can be transmitted between the UE and the base station.

RRC_INACTIVE: The mobility is based on cell reselection by the UE, there is a connection between the CN and the NR, the UE AS context exists in a base station, the paging is triggered by a radio access network (RAN), an RAN-based paging area is managed by the RAN, and the network side is aware of an RAN paging area level-based location of the UE.

### Application Scenario of Reduced Capability (RedCap) Terminal

In addition to the application scenarios such as eMBB and URLLC, the application examples for example industrial wireless sensors, video surveillance, wearable device and other terminal Internet of Things (IoT) devices put forward, for a 5G terminal, new requirements such as low complexity and cost, size calibration and low energy consumption. Therefore, a RedCap terminal is introduced into NR systems. At present, the RedCap terminal mainly can be applied to following three scenarios.

(1) Industrial wireless sensors. Compared with URLLC, industrial wireless sensors have relatively low requirements for latency and reliability. The cost and power consumption of the devices are also lower than those of URLLC and eMBB. The main requirements and features of this type of terminal include: communication reliability up to 99.99%, an end-to-end latency less than 100 milliseconds (ms), a reference data rate less than 2 megabits per second (Mbps) and mainly focused on uplink services, static equipment, and a battery life of several years. For safety-related sensors, a latency requirement is lower, ranging from 5 to 10 ms.

(2) Video surveillance, mainly including video surveillance scenarios such as smart city and industrial factory. The collection and processing of data in the smart city facilitate to monitor and control urban resources more effectively, and provide more effective services for urban residents. Video surveillance is mainly focused on uplink services. Other main requirements further include a reference rate ranging from 2 Mbps to 4 Mbps for a regular resolution video, latency less than 500 ms, the communication reliability ranging from 99% to 99.9%, and a rate requirement ranging from 7.5 Mbps to 25 Mbps for a high-definition video.

(3) Wearables, including smart watches, smart bracelets, electronic health devices and some medical monitoring devices. A common feature of the wearables includes their small size. The key indicators required for the wearables include downlink and uplink reference rates ranging from 5 Mbps to 50 Mbps, and 2 Mbps to 5 Mbps, respectively, peak downlink and uplink rates being 150 Mbps and 50 Mbps, respectively. The battery is required to work for several days or even 1 to 2 weeks.

### RRM Measurement by UE in Non-Connected State in R15

A terminal in a non-connected state needs to perform RRM measurement on a serving cell and another neighboring cell based on network configuration to support mobility operations such as cell reselection.

The UE in the non-connected state continuously performs measurement on the serving cell.

In NR Rel-15, for terminal power saving, when the quality channel of the UE in the serving cell is good, the UE may not enable RRM measurement for intra-frequencies nor equal-priority or lower-priority inter-frequencies/inter-technology frequencies, and may perform relaxed RRM measurement for higher-priority inter-frequencies/inter-technology frequencies, which is specifically as follows.

For intra-frequencies, if Srxlev (signal receiving power in cell search) measured for the serving cell is higher than a threshold S_{IntraSearchP} and Squal (signal receiving quality in cell search) is higher than a threshold S_{IntraSearchQ}, the UE can disable measurement of all intra-frequency neighboring cells.

For lower-priority or equal-priority NR inter-frequencies or inter-technology frequencies, if Srxlev measured for the serving cell is higher than a threshold S_{nonIntraSearchP} and Squal is higher than a threshold S_{nonIntraSearchQ}, the UE can disable measurement of all lower-priority or equal-priority NR inter-frequencies or inter-technology frequencies.

For higher-priority NR inter-frequencies or inter-technology frequencies, if Srxlev measured for the serving cell is higher than the threshold S_{nonIntraSearchQ} and Squal is higher than the threshold S_{nonIntraSearchQ}, the UE can perform relaxed measurement for higher-priority NR inter-frequencies or inter-technology frequencies. In this case, for each higher-priority frequency, the measurement gap is relaxed to T_{higher_priority_search}=(60*N_{layers}) seconds(s), where N_{layers} is the number of higher-priority frequencies broadcast by the network.

The parameters S_{IntraSearchP}, S_{IntraSearchQ}, S_{nonIntraSearchP}, and S_{nonIntraSearchQ} are configured by the network through a system information block (SIB) 2.

In NR, cell measurement requirements include T_{detect}, Tₘₑₐₛᵤᵣₑ, and Tₑᵥₐₗᵤₐₜₑ, which are times used for cell detection, cell measurement, and cell evaluation, respectively. These requirements are usually related to a discontinuous reception (DRX) cycle of the terminal.

### RRM Measurement Relaxation of UE in Non-Connected State in R16 NR

R16 introduces a neighboring cell measurement relaxation mechanism for UEs in a non-connected state, to further meet the needs of terminal power saving.

To support relaxed neighboring cell measurement, a low mobility criterion and a not-at-cell-edge criterion are introduced. Both criterions are based on results of measurement by the UE on the serving cell. The low mobility criterion and the not-at-cell-edge criterion are defined in standards as follows.

(1) Low mobility criterion, also known as stationary criterion, for which the network may configure an evaluation duration T_{SearchDeltaP} of reference signal receiving power (RSRP) variation, and a RSRP variation threshold S_{SearchDeltaP}. A UE is considered to meet the low mobility criterion if the RSRP variation of the UE on the serving cell within a duration T_{SearchDeltaP} is less than S_{SearchDeltaP}, i.e., within a duration T_{SearchDeltaP}, the following is met:

$$( SrxlevRef - Srxlev ) < {S}_{SearchDeltaP} , \qquad ( 1 )$$

where Srxlev is a current Srxlev measurement value of the serving cell, and SrxlevRef is a reference Srxlev value of the serving cell.

When the UE selects or reselects a new cell, or if (Srxlev−SrxlevRef)>0, or if the UE fails to meet formula (1) within a duration T_{SearchDeltaP}, then the UE sets SrxlevRef to the current Srxlev measurement value of the serving cell, and after completing cell selection/reselection, the UE needs to perform normal RRM measurement within at least a duration T_{SearchDeltaP}.

(2) Not-at-cell-edge criterion, for which the network may configure an RSRP threshold S_{SearchThresholdP} and a reference signal receiving quality (RSRQ) threshold S_{SearchThresholdQ}. When the RSRP of the UE in the serving cell is greater than the RSRP threshold, and if an RSRQ threshold is configured by the network and the RSRQ of the UE in the serving cell is greater than the RSRQ threshold, then the UE is considered to meet the not-at-cell-edge criterion.

The network notifies the UE via system broadcast whether the RRM measurement relaxation function can be enabled. When the RRM measurement relaxation function is enabled, the network needs to configure at least one RRM measurement relaxation judgment criterion. For different configurations, the following four cases may exist.

Case 1: The network only configures a low mobility criterion. When the UE meets the low mobility criterion, the UE enables relaxed RRM measurement on a neighboring cell.

Case 2: The network only configures a not-at-cell-edge criterion. When the UE meets the not-at-cell-edge criterion, the UE performs relaxed RRM measurement on a neighboring cell.

Case 3: The network configures both a low mobility criterion and a not-at-cell-edge criterion, and the network does not configure a parameter combineRelaxedMeasCondition. In this case, when the UE meets at least one of the two criterion, the UE enables relaxed RRM measurement on a neighboring cell.

Case 4: The network configures both a low mobility criterion and a not-at-cell-edge criterion, and the network configures a parameter combineRelaxedMeasCondition. In this case, when UE meets both criterions, the UE enables relaxed RRM measurement on a neighboring cell.

For a UE in a non-connected state, there are following two RRM measurement relaxation manners.

Manner 1: When the UE only meets the low mobility criterion or the not-at-cell-edge criterion, for intra-frequency measurement, NR inter-frequency measurement, and inter-technology inter-frequency measurement, the measurement gap is relaxed to three times a normal measurement gap.

Manner 2: When the UE meets both the low mobility criterion and the not-at-cell-edge criterion, for intra-frequency measurement, NR inter-frequency measurement, and inter-technology inter-frequency measurement, the measurement gap can be relaxed to one hour.

In addition, for higher-priority frequencies, a parameter highPriorityMeasRelax is introduced. This parameter indicates whether the network allows the measurement gap of the UE on higher-priority frequencies to be relaxed to a value exceeding T_{higher_priority_search} (except when the UE meets both the low mobility criterion and the not-at-cell-edge criterion). In other words, the parameter highPriorityMeasRelax is only used to control a case where the network configures only the low mobility criterion, the UE meets the low mobility criterion, and a measurement result of the UE in the serving cell meets that Srxlev is greater than S_{nonIntraSearchP} and Squal is greater than S_{nonIntraSearchQ}. In this case, if the network configures the parameter highPriorityMeasRelax, the measurement gap of the UE on higher-priority frequencies can be relaxed to K2*T_{higher_priority_search}, where K2 is 60. If the network does not configure the parameter highPriorityMeasRelax, the measurement gap of the UE on higher-priority frequencies is T_{higher_priority_search}.

Based on the low mobility criterion and the not-at-cell-edge criterion, further RRM measurement relaxation, including measurement relaxation for the low mobility criterion and the not-at-cell-edge criterion, can be added for RedCap terminals. Regarding RedCap terminals, in NR, UE power classes of 23 dBm and 26 dBm are currently supported. In related technologies, it is also proposed to introduce a lower UE power class to further reduce terminal power consumption.

In SL scenarios, the UE needs to perform RRM measurement to select an appropriate serving relay terminal (relay UE) or network node, etc. In these scenario, how to reduce terminal power consumption needs to be considered.

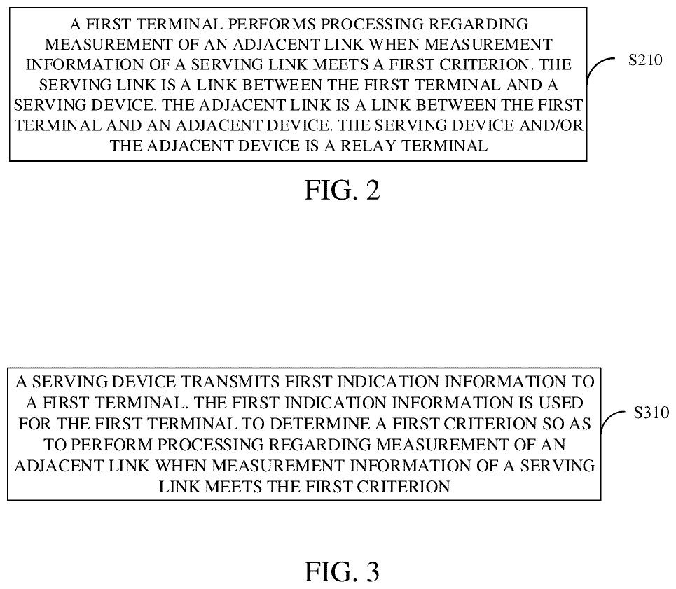

FIG. 2 is a schematic flowchart of a measurement method 200 according to an embodiment of the disclosure. Optionally, the method may be applied to the system illustrated in FIG. 1, but is not limited thereto. The method includes at least part of the following.

S210. A first terminal performs processing regarding measurement of an adjacent link when measurement information of a serving link meets a first criterion. The serving link is a link between the first terminal and a serving device. The adjacent link is a link between the first terminal and an adjacent device. The serving device and/or the adjacent device is a relay terminal.

Exemplarily, the serving device in embodiments of the disclosure may include a network device of a serving cell where the first terminal is located or a serving relay terminal of the first terminal. The serving relay terminal may be a relay terminal between the first terminal and a second terminal, i.e., the serving relay terminal may be used for terminal-to-terminal relay (UE-to-UE relay). Alternatively, the serving relay terminal may be a relay terminal between the first terminal and the network device of the serving cell where the first terminal is located, i.e., the serving relay terminal may be used for terminal-to-network relay (UE-to-NW relay).

Exemplarily, the adjacent device in embodiments of the disclosure may include a network device of a neighboring cell of the serving cell where the first terminal is located or a relay terminal corresponding to the first terminal. The relay terminal corresponding to the first terminal may be another terminal that can be used to relay for the first terminal. For example, the relay terminal may be another relay terminal other than a serving relay terminal between the first terminal and the network device of the serving cell, or another relay terminal other than a serving relay terminal between the first terminal and the second terminal, or a relay terminal between the first terminal and the network device of the neighboring cell.

In embodiments of the disclosure, at least one of the serving device or the adjacent device is a relay terminal. That is, the method can be applied in SL relay scenarios. It can be understood that the first terminal can be a remote terminal (remote UE) in scenarios such as terminal-to-terminal relay or terminal-to-network relay.

In an exemplary scenario, the serving device is a serving relay terminal between the first terminal and the second terminal, and the adjacent device is another relay terminal between the first terminal and the second terminal.

In another exemplary scenario, the serving device is a serving relay terminal between the first terminal and the network device of the serving cell where the first terminal is located, and the adjacent device is a network device of the neighboring cell of the serving cell where the first terminal is located.

In another exemplary scenario, the serving device is a network device of the serving cell where the first terminal is located, and the adjacent device is a relay terminal corresponding to the first terminal. Optionally, the relay terminal can be a relay terminal between the first terminal and the network device of the serving cell where the first terminal is located, or a relay terminal between the first terminal and the network device of the neighboring cell of the serving cell where the first terminal is located.

It should be noted that in embodiments of the disclosure, the serving device and the adjacent device may be different devices or the same device. For example, the serving device and the adjacent device may be the same device, and the device establishes two logically different links with the first terminal, one of the two links is the serving link of the first terminal.

According to the above method, in SL relay scenarios, when the measurement information of the serving link meets the first criterion, predetermined processing is performed for the measurement of the adjacent link. As such, the measurement of the adjacent link can be adjusted timely, which is conducive to reducing terminal power consumption.

Exemplarily, the measurement information in embodiments of the disclosure may include a measurement result of a channel quality. In some implementations, the measurement information may include a RSRP and/or a RSRQ.

Exemplarily, the first criterion may include any criterion for determining whether the measurement information of the serving link meets requirements. In practical applications, the first criterion may include a parameter related to the measurement information, so that the parameter can be used to determine whether the channel quality of the serving link meets requirements.

Exemplarily, the parameter of the first criterion may include a threshold. Optionally, the threshold may include an RSRP threshold and/or an RSRQ threshold. For example, when the RSRP of the serving link is greater than the RSRP threshold, the measurement information of the serving link is determined to meet the first criterion. For another example, when the RSRP of the serving link is greater than the RSRP threshold and the RSRQ of the serving link is greater than the RSRQ threshold, the measurement information of the serving link is determined to meet the first criterion.

Optionally, the first criterion may include at least one of: a not-at-cell-edge criterion, a stationary criterion, or a low mobility criterion. The specific setting manner may refer to aforementioned related technologies, which is not repeated herein.

Exemplarily, in embodiments of the disclosure, the processing regarding the measurement on the adjacent link may include a predefined processing related to adjusting measurement configuration.

Optionally, performing the processing regarding the measurement of the adjacent link may include disabling the measurement of the adjacent link.

Optionally, performing the processing regarding the measurement of the adjacent link may include relaxing the measurement of the adjacent link. Exemplarily, the measurement of the adjacent link may be relaxed by increasing a measurement gap for the adjacent link or using a preset measurement gap for relaxing the measurement. For example, the measurement gap may be adjusted to M times a normal measurement gap, where M is greater than 1. For another example, the measurement gap may be adjusted to one hour, two hours, or the like.

Optionally, performing the processing regarding the measurement of the adjacent link may include transmitting first reporting information, where the first reporting information is used to determine whether to adjust the measurement of the adjacent link. Specifically, the first reporting information may be transmitted to the serving device to report to the serving device that the measurement information of the serving link meets the first criterion. In practical applications, the serving device may be a network device of a serving cell where the first terminal is located.

Accordingly, in embodiments of the disclosure, the measurement method may include the following. The serving device receives the first reporting information from the first terminal, and determines whether to adjust the measurement of the adjacent link by the first terminal based on the first reporting information.

Optionally, when the measurement information of the serving link fails to meet the first criterion, the first terminal may not perform the processing regarding the measurement. For example, the first terminal may continue to measure the adjacent link based on a normal measurement gap.

In embodiments of the disclosure, multiple manners for determining the first criterion may be provided.

Optionally, the first criterion may be preconfigured, configured by a network device, or configured by the serving device.

Optionally, the first criterion may be determined according to received first indication information. Specifically, before S210, the measurement method may further include the following. The first terminal receives the first indication information, where the first indication information is used to determine the first criterion. The first indication information may come from the serving device of the first terminal, such as a network device of a serving cell of the first terminal or a serving relay terminal of the first terminal.

Accordingly, the disclosure further provides a measurement method. FIG. 3 illustrates a schematic flowchart of a measurement method 300 according to another embodiment of the disclosure. As illustrated in FIG. 3, the method may include the following.

S310. A serving device transmits first indication information to a first terminal. The first indication information is used for the first terminal to determine a first criterion so as to perform processing regarding measurement of an adjacent link when measurement information of a serving link meets the first criterion. The serving link is a link between the first terminal and the serving device. The adjacent link is a link between the first terminal and an adjacent device. The serving device and/or the adjacent device is a relay terminal.

Optionally, the first indication information is carried by at least one of: a Uu interface (an interface between a UE and a network device) signaling, an SL signaling, an SL RRC signaling, or an SL discovery message. The SL signaling is, for example, a PC5-S signaling. The SL RRC signaling is, for example, a PC5-RRC signaling. The SL discovery message is, for example, a prose direct discovery message.

In some examples, the first indication information may indicate the first criterion. That is, the first criterion may be determined by the serving device and indicated by the serving device by transmitting the first indication information.

Exemplarily, the first indication information may contain a parameter in the first criterion. For example, the first indication information includes a RSRP threshold and/or a RSRP threshold.

Optionally, the first criterion is preconfigured, or configured by a network device. For example, when the serving device is a serving relay terminal, the serving device may determine the first criterion according to preconfigured information or network configured-information. When the serving device is a network device of a serving cell where the first terminal is located, the serving device may determine the first criterion according to preconfigured information.

Optionally, the first criterion is determined based on a transmission power class of the serving device. Exemplarily, before the serving device transmits the first indication information to the first terminal, the measurement method may further include the following. The serving device determines the first criterion based on a transmission power class of the serving device.

Optionally, the serving device may determine the first criterion based on the transmission power class of the serving device as follows. The serving device determines the first criterion based on the transmission power class of the serving device and at least one criterion.

Exemplarily, the serving device may determine a correspondence between at least one transmission power class and the at least one criterion, and then determine the first criterion based on the correspondence and the transmission power class of the serving device.

Optionally, the serving device determines the first criterion based on the transmission power class of the serving device and the at least one criterion as follows. The serving device selects the first criterion from the at least one criterion based on the transmission power class of the serving device.

Specifically, the serving device may select the first criterion corresponding to the transmission power class of the serving device from the at least one criterion based on the correspondence between the at least one transmission power and the at least one criterion.

Optionally, the serving device determines the first criterion based on the transmission power class of the serving device and the at least one criterion as follows. The serving device processes a second criterion among the at least one criterion based on the transmission power class of the serving device to obtain the first criterion.

Specifically, if the at least one criterion is one criterion, that is, the at least one criterion includes only the second criterion, the serving device may process the second criterion based on the transmission power class of the serving device to obtain the first criterion. If the at least one criterion is multiple criterions, the serving device may select the second criterion from the multiple criterions based on the transmission power class of the serving device, and then process the second criterion based on the transmission power class of the serving device to obtain the first criterion.

For example, if the at least one criterion includes a second criterion corresponding to 20 dBm, and the transmission power class of the serving device is 23 dBm, a target threshold is calculated based on the difference or the ratio between 20 dBm and 23 dBm and a threshold in the second criterion, and the first criterion is determined based on the target threshold.

Optionally, the at least one criterion is preconfigured, or configured by a network device. For example, the serving device is a serving relay terminal between the first terminal and a network device of a serving cell, and the serving relay terminal may determine the at least one criterion based on preconfigured information or configuration of the network device of the serving cell. For another example, the serving device is a network device of a serving cell, and the network device may determine the at least one criterion based on preconfigured information.

Optionally, a parameter in the at least one criterion includes a threshold, the threshold is related to the measurement information, and the threshold is preconfigured, or configured by a network device. The measurement information may include a RSRP and/or a RSRQ.

In various optional manners above, the correspondence between the at least one transmission power and the at least one criterion may be determined in an explicit manner or an implicit manner.

As an example of the explicit manner, the measurement method in embodiments of the disclosure may further include the following. The serving device receives third indication information, where the third indication information indicates a correspondence between at least one transmission power class and the at least one criterion. The serving device may be a serving relay terminal, and the third indication information may be transmitted by a network device of a serving cell.

As an example of the implicit manner, the measurement method in embodiments of the disclosure may further include the following. The serving device determines a correspondence between at least one transmission power class and the at least one criterion based on a threshold in the at least one criterion.

Optionally, the serving device determines the correspondence between the at least one transmission power class and the at least one criterion based on the threshold in the at least one criterion as follows. The serving device determines the correspondence between the at least one transmission power class and the at least one criterion based on an order of magnitude of the threshold in the at least one criterion and an order of magnitude of the at least one transmission power class.

For example, there is a one-to-one correspondence between the at least one transmission power class and the at least one criterion. The at least one criterion is sorted in descending order of its corresponding RSRP/RSRQ threshold, and the at least one transmission power class is sorted in descending order. Then, the nth transmission power class corresponds to the nth criterion, where n is an integer greater than or equal to 1, and n is less than or equal to the number of criterions.

According to the multiple examples above, the serving device can directly indicate the first criterion in the first indication information, so that the first terminal can determine the first criterion based on the first indication information, and then after measuring a channel quality of the serving link, determine whether to perform the processing on the adjacent link based on whether the measurement information meets the first criterion.

In some other examples, the first indication information may indicate other information used to determine the first criterion, so that the first terminal can determine the first criterion based on the information. Exemplarily, the first indication information may indicate the transmission power class of the serving device, so that the first terminal can determine the first criterion based on the transmission power class of the serving device.

Optionally, after receiving the first indication information, the measurement method of embodiments of the disclosure may further include the following. The first terminal determines the first criterion based on the transmission power class of the serving device and at least one criterion.

Exemplarily, the first terminal may determine a correspondence between at least one transmission power class and the at least one criterion, and then determine the first criterion based on the correspondence and the transmission power class of the serving device.

Optionally, the first terminal determines the first criterion based on the transmission power class of the serving device and the at least one criterion as follows. The first terminal selects the first criterion from the at least one criterion based on the transmission power class of the serving device.

Specifically, the first terminal may select the first criterion corresponding to the transmission power class of the serving device from the at least one criterion based on the correspondence between the at least one transmission power and the at least one criterion.

Optionally, the first terminal determines the first criterion based on the transmission power class of the serving device and the at least one criterion as follows. The first terminal processes a second criterion among the at least one criterion based on the transmission power class of the serving device to obtain the first criterion.

Specifically, if the at least one criterion is one criterion, that is, the at least one criterion includes only the second criterion, the first terminal may process the second criterion based on the transmission power class to obtain the first criterion. If the at least one criterion is multiple criterions, the first terminal may select the second criterion from the multiple criterions based on the transmission power class of the serving device, and then process the second criterion based on the transmission power class of the serving device to obtain the first criterion.

Optionally, the at least one criterion is preconfigured, configured by a network device, or configured by the serving device. For example, the serving device is a serving relay terminal of the first terminal, and the first terminal may determine the at least one criterion based on preconfigured information, configuration of a network device in a serving cell, or configuration of the serving relay terminal. For another example, the serving device is a network device of a serving cell of the first terminal, and the first terminal may determine the at least one criterion based on preconfigured information or configuration of the network device.

Optionally, a parameter in the at least one criterion includes a threshold, the threshold is related to the measurement information, and the threshold is preconfigured, configured by a network device, or configured by the serving device. The measurement information may include a RSRP and/or a RSRQ.

In various optional manners above, the correspondence between the at least one transmission power and the at least one criterion may be determined in an explicit manner or an implicit manner.

As an example of the explicit manner, the measurement method may further include the following. The first terminal receives second indication information, where the second indication information indicates a correspondence between at least one transmission power class and the at least one criterion. The second indication information may be transmitted by a serving device or a network device.

As an example of the implicit manner, the measurement method may further include the following. The first terminal determines a correspondence between at least one transmission power class and the at least one criterion based on a threshold in the at least one criterion.

Optionally, the first terminal determines the correspondence between the at least one transmission power class and the at least one criterion based on the threshold in the at least one criterion as follows. The first terminal determines the correspondence between the at least one transmission power class and the at least one criterion based on an order of magnitude of the threshold in the at least one criterion and an order of magnitude of the at least one transmission power class.

According to the multiple examples above, the serving device can indicate the transmission power class of the serving device in the first indication information to indirectly indicate the first criterion, so that the first terminal can determine the first criterion, and then after measuring a channel quality of the serving link, determine whether to perform the processing on the adjacent link based on whether the measurement information meets the first criterion.

Several application examples are provided below to illustrate the above solutions.

### Application Example 1

In this application example, to illustrate the above solutions, for example, the first terminal is a remote terminal (remote UE), the serving device is a serving relay terminal (relay UE) between the first terminal and a second terminal, and the adjacent device is another relay terminal between the first terminal and the second terminal. The specific implementation includes the following.

1. The remote terminal or the serving relay terminal receives information, which is configured by a network or preconfigured, related to RRM measurement relaxation for the remote terminal. The information includes the following.

a) At least one criterion. The at least one criterion includes at least one of: a not-at-cell-edge criterion, a stationary criterion, or a low mobility criterion. Each of the at least one criterion includes an RSRP threshold and optionally an RSRQ threshold.

b) A correspondence between the at least one criterion and at least one UE transmission power class. The correspondence is notified explicitly or determined implicitly.

The explicit notification may be used in a case where one criterion corresponds to at least one UE transmission power class.

The implicit determination is applicable to a case where there is a one-to-one correspondence between criterions and UE transmission power classes. Specifically, the correspondence between N criterions and N UE transmission power classes can be determined by sorting the N criterions in descending order of their corresponding RSRP/RSRQ thresholds, and sorting the N UE transmission power classes in descending order of powers, so that the nth criterion corresponds to the nth UE transmission power class, where Nis an integer greater than or equal to 1, and n is an integer greater than or equal to 1 and less than or equal to N.

2. Optionally, the relay terminal determines a first criterion corresponding to a serving range of the relay terminal based on the at least one criterion and the correspondence, and in combination with a transmission power class of the relay terminal. The relay terminal transmits first indication information to the remote UE to indicate the first criterion. For example, the first indication information can be carried by a PC5-S signaling, a PC5-RRC signaling, a prose direct discovery, etc.

Alternatively, optionally, the remote terminal determines a first criterion corresponding to a serving range of the relay terminal based on the at least one criterion and the correspondence between the at least one criterion and the at least one UE transmission power class, and in combination with a transmission power class of the relay terminal. The transmission power class is indicated by the relay terminal by transmitting first indication information to the remote UE. For example, the first indication information can be carried by a PC5-S signaling, a PC5-RRC signaling, a prose direct discovery, etc.

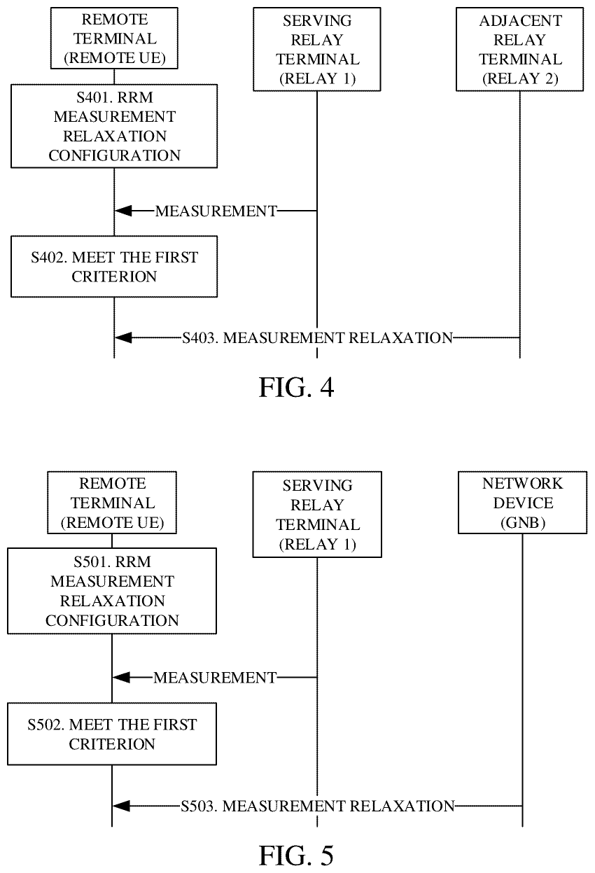

3. As illustrated in FIG. 4, the following steps are included.

S401. The remote UE determines related configuration, including the above RRM measurement relaxation configuration.

S402. The first criterion is determined to be met based on a measurement result of a channel quality of the serving relay terminal (for example, relay 1).

S403. The remote UE performs processing related to measurement relaxation, including: disabling RRM measurement for an adjacent relay terminal (for example, relay 2); or enabling relaxed RRM measurement for the adjacent relay terminal, such as increasing a measurement gap to M times a normal measurement gap (M>1), or using a fixed measurement gap such as 1 hour.

### Application Example 2

In this application example, to illustrate the above solutions, for example, the first terminal is a remote terminal (remote UE), the serving device is a serving relay terminal (relay UE) of the first terminal, and the adjacent device is a device of a neighboring cell. The specific implementation includes the following.

1. The remote terminal or the relay terminal receives information, which is configured by a network or preconfigured, related to RRM measurement relaxation for the remote terminal. The information includes the following.

a) At least one criterion. The at least one criterion includes at least one of: a not-at-cell-edge criterion, a stationary criterion, or a low mobility criterion. Each of the at least one criterion includes an RSRP threshold and optionally an RSRQ threshold.

b) A correspondence between the at least one criterion and at least one UE transmission power class. The correspondence is notified explicitly or determined implicitly.

The explicit notification may be used in a case where one criterion corresponds to at least one UE transmission power class.

The implicit determination is applicable to a case where there is a one-to-one correspondence between criterions and UE transmission power classes. Specifically, the correspondence between N criterions and N UE transmission power classes can be determined by sorting the N criterions in descending order of their corresponding RSRP/RSRQ thresholds, and sorting the N UE transmission power classes in descending order of powers, so that the nth criterion corresponds to the nth UE transmission power class, where N is an integer greater than or equal to 1, and n is an integer greater than or equal to 1 and less than or equal to N.

2. Optionally, the relay terminal determines a first criterion corresponding to a serving range of the relay terminal based on the at least one criterion and the correspondence, and in combination with a transmission power class of the relay terminal. The relay terminal transmits first indication information to the remote UE to indicate the first criterion. For example, the first indication information can be carried by a PC5-S signaling, a PC5-RRC signaling, a prose direct discovery, etc.

Alternatively, optionally, the remote terminal determines a first criterion corresponding to a serving range of the relay terminal based on the at least one criterion and the correspondence between the at least one criterion and the at least one UE transmission power class, and in combination with a transmission power class of the relay terminal. The transmission power class is indicated by the relay terminal by transmitting first indication information to the remote UE. For example, the first indication information can be carried by a PC5-S signaling, a PC5-RRC signaling, a prose direct discovery, etc.

3. As illustrated in FIG. 5, the following steps are included.

S501. The remote terminal determines related configuration, including the above RRM measurement relaxation configuration.

S502. The first criterion is determined to be met based on a measurement result of a channel quality of the serving relay terminal (for example, relay 1).

S503. The remote terminal performs processing related to measurement relaxation, including: disabling RRM measurement for a neighboring cell (for example, a gNB of the neighboring cell); or enabling relaxed RRM measurement for the neighboring cell, such as increasing a measurement gap to M times a normal measurement gap (M>1), or using a fixed measurement gap such as 1 hour.

### Application Example 3

In this application example, to illustrate the above solutions, for example, the first terminal is a remote terminal, the serving device is a network device (or a network node) in a serving cell where the first terminal is located, and the adjacent device is an adjacent relay UE (for example, a relay UE in the serving cell or a relay UE in a neighboring cell). The specific implementation includes the following.

1. The remote terminal or the relay terminal receives information, which is configured by a network or preconfigured, related to RRM measurement relaxation for the remote terminal. The information includes the following.

At least one criterion. The at least one criterion includes at least one of: a not-at-cell-edge criterion, a stationary criterion, or a low mobility criterion. Each of the at least one criterion includes an RSRP threshold and optionally an RSRQ threshold.

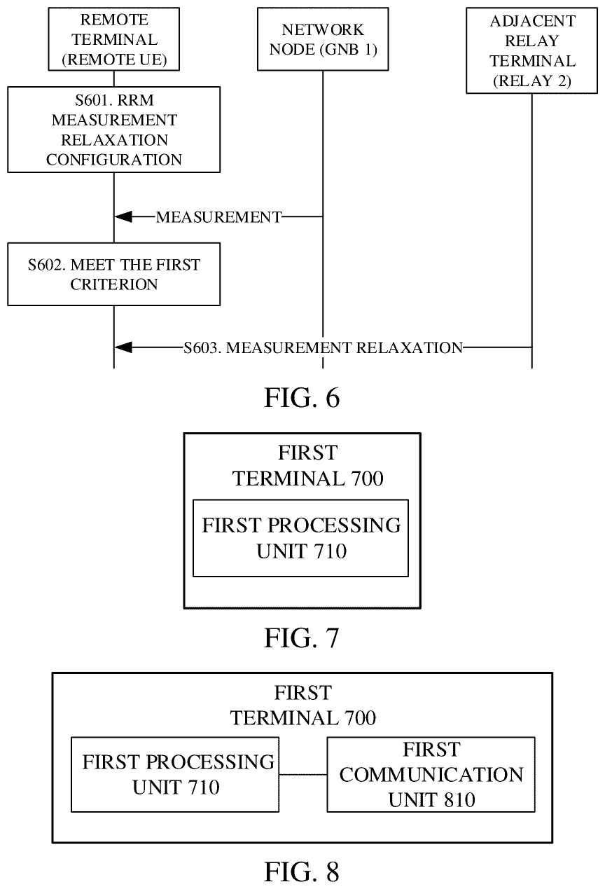

2. As illustrated in FIG. 6, the following steps are included.

S601. The remote terminal determines related configuration, including the above RRM measurement relaxation configuration.

S602. The remote terminal determines that the first criterion is met based on a measurement result of a channel quality of the serving cell.

S603. The remote terminal performs processing related to measurement relaxation, including: disabling RRM measurement for an adjacent relay terminal (for example, relay 2); enabling relaxed RRM measurement for the adjacent relay terminal, such as increasing a measurement gap to M times a normal measurement gap (M>1), or using a fixed measurement gap such as 1 hour; or transmitting reporting information to the network node so that the network node can determine whether to adjust the measurement of the adjacent relay terminal.

As can be seen, embodiments of the disclosure provide a method for terminal RRM measurement relaxation in SL relay scenarios. With this method, low-mobility/stationary UEs or UEs in the center of the service coverage area can perform relaxed RRM measurement. As such, the needs of terminal mobility management can be met, and the needs of terminal power saving can be considered.

FIG. 7 is a schematic structural diagram of a first terminal 700 according to embodiments of the disclosure. The first terminal 700 may include a first processing unit 710. The first processing unit 710 is configured to perform processing regarding measurement of an adjacent link when measurement information of a serving link meets a first criterion. The serving link is a link between the first terminal 700 and a serving device. The adjacent link is a link between the first terminal 700 and an adjacent device. The serving device and/or the adjacent device is a relay terminal.

In an implementation, the serving device is a serving relay terminal between the first terminal 700 and a second terminal, and the adjacent device is another relay terminal between the first terminal 700 and the second terminal.

In an implementation, the serving device is a serving relay terminal between the first terminal 700 and a network device of a serving cell where the first terminal 700 is located, and the adjacent device is a network device of a neighboring cell of the serving cell where the first terminal 700 is located.

In an implementation, the serving device is a network device of a serving cell where the first terminal 700 is located, and the adjacent device is a relay terminal corresponding to the first terminal 700.

In an implementation, performing the processing regarding the measurement of the adjacent link includes one of: disabling the measurement of the adjacent link; relaxing the measurement of the adjacent link; or transmitting first reporting information. The first reporting information is used for a network device to determine whether to adjust the measurement of the adjacent link.

In an implementation, the first criterion is preconfigured, configured by a network device, or configured by the serving device.

FIG. 8 is a schematic structural diagram of a first terminal 700 according to another embodiment of the disclosure. The first terminal 700 may include one or more features of the above embodiments. As illustrated in FIG. 8, the first terminal 700 may further include a first communication unit 810. The first communication unit 810 is configured to receive first indication information. The first indication information is used to determine the first criterion.

In an implementation, the first indication information indicates a transmission power class of the serving device.

In an implementation, the first processing unit 710 is further configured to: determine the first criterion based on the transmission power class of the serving device and at least one criterion.

In an implementation, the first processing unit 710 is further configured to: select the first criterion from the at least one criterion based on the transmission power class of the serving device.

In an implementation, the first processing unit 710 is further configured to: process a second criterion among the at least one criterion based on the transmission power class of the serving device to obtain the first criterion.

In an implementation, the at least one criterion is preconfigured, configured by a network device, or configured by the serving device.

In an implementation, a parameter in the at least one criterion includes a threshold, the threshold is related to the measurement information, and the threshold is preconfigured, configured by a network device, or configured by the serving device.

In an implementation, the measurement information includes a RSRP and/or a RSRQ.

In an implementation, the first communication unit 810 is further configured to: receive second indication information. The second indication information indicates a correspondence between at least one transmission power class and the at least one criterion.

In an implementation, the first processing unit 710 is further configured to: determine a correspondence between at least one transmission power class and the at least one criterion based on a threshold in the at least one criterion.

In an implementation, the first processing unit 710 is further configured to: determine the correspondence between the at least one transmission power class and the at least one criterion based on an order of magnitude of the threshold in the at least one criterion and an order of magnitude of the at least one transmission power class.

In an implementation, the first indication information indicates the first criterion, and the first criterion is determined by the serving device.

In an implementation, the first indication information is carried by at least one of: a Uu interface signaling, a sidelink (SL) signaling, an SL RRC signaling, or an SL discovery message.

In an implementation, the first criterion includes at least one of: a not-at-cell-edge criterion; a stationary criterion; or a low mobility criterion.

The first terminal 700 in embodiments of the disclosure can implement corresponding functions of the first terminal 700 in the foregoing method embodiments. For the procedure, function, implementation, and advantage corresponding to each module (sub-module, unit, or assembly, etc.) in the first terminal 700, reference can be made to the corresponding illustrations in the foregoing method embodiments, which will not be described in detail again herein. It should be noted that, the functions of various modules (sub-modules, units, or assemblies, etc.) in the first terminal 700 described in embodiments of the disclosure may be implemented by different modules (sub-modules, units, or assemblies, etc.), or may be implemented by the same module (sub-module, unit, or assembly, etc.).

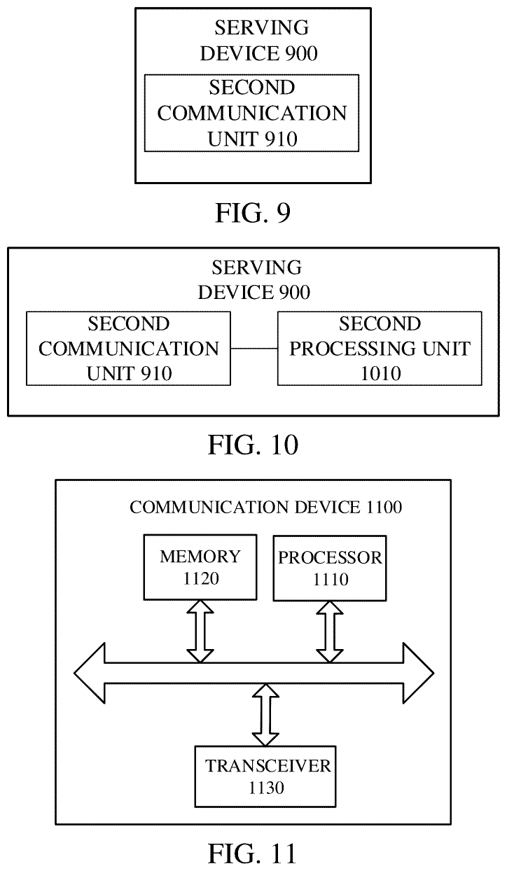

FIG. 9 is a schematic structural diagram of a serving device 900 according to an embodiment of the disclosure. The serving device 900 may include a second communication unit 910. The second communication unit 910 is configured transmit first indication information to a first terminal. The first indication information is used for the first terminal to determine a first criterion so as to perform processing regarding measurement of an adjacent link when measurement information of a serving link meets the first criterion. The serving link is a link between the first terminal and the serving device. The adjacent link is a link between the first terminal and an adjacent device. The serving device and/or the adjacent device is a relay terminal.

In an implementation, the serving device 900 includes a serving relay terminal of the first terminal or a network device of a serving cell where the first terminal is located.

In an implementation, the first indication information indicates a transmission power class of the serving device 900.

In an implementation, the first indication information indicates the first criterion.

In an implementation, the first criterion is preconfigured, or configured by a network device.

FIG. 10 illustrates a schematic structural diagram of a serving device 900 according to another embodiment of the disclosure. The serving device 900 may include one or more features of the above embodiments. As illustrated in FIG. 10, the serving device 900 further includes a second processing unit 1010. The second processing unit 1010 is configured to determine the first criterion based on a transmission power class of the serving device.

In an implementation, the second processing unit 1010 is configured to: determine the first criterion based on the transmission power class of the serving device and at least one criterion.

In an implementation, the second processing unit 1010 is configured to: select the first criterion from the at least one criterion based on the transmission power class of the serving device.

In an implementation, the second processing unit 1010 is configured to: process a second criterion among the at least one criterion based on the transmission power class of the serving device to obtain the first criterion.

In an implementation, the at least one criterion is preconfigured, or configured by a network device.

In an implementation, a parameter in the at least one criterion includes a threshold, the threshold is related to the measurement information, and the threshold is preconfigured, or configured by a network device.

In an implementation, the measurement information includes a RSRP and/or a RSRQ.

In an implementation, the second communication unit 910 is further configured to: receive third indication information. The third indication information indicates a correspondence between at least one transmission power class and the at least one criterion.

In an implementation, the second processing unit 1010 is further configured to: determine a correspondence between at least one transmission power class and the at least one criterion based on a threshold in the at least one criterion.

In an implementation, the second processing unit 1010 is further configured to: determine the correspondence between the at least one transmission power class and the at least one criterion based on an order of magnitude of the threshold in the at least one criterion and an order of magnitude of the at least one transmission power class.

In an implementation, the second communication unit 910 is further configured to: receive first reporting information from the first terminal; and determine whether to adjust the measurement of the adjacent link by the first terminal based on the first reporting information.

In an implementation, the first indication information is carried by at least one of: a Uu interface signaling, an SL signaling, an SL RRC signaling, or an SL discovery message.

In an implementation, the first criterion includes at least one of: a not-at-cell-edge criterion; a stationary criterion; or a low mobility criterion.

The serving device 900 in embodiments of the disclosure can implement corresponding functions of the serving device in the foregoing method embodiments. For the procedure, function, implementation, and advantage corresponding to each module (sub-module, unit, or assembly, etc.) in the serving device 900, reference can be made to the corresponding illustrations in the foregoing method embodiments, which will not be described in detail again herein. It should be noted that, the functions of various modules (sub-modules, units, or assemblies, etc.) in the serving device 900 described in embodiments of the disclosure may be implemented by different modules (sub-modules, units, or assemblies, etc.), or may be implemented by the same module (sub-module, unit, or assembly, etc.).

FIG. 11 is a schematic structural diagram of a communication device 1100 according to embodiments of the disclosure. The communication device 1100 includes a processor 1110. The processor 1110 is configured to invoke and execute computer programs stored in a memory to cause the communication device 1100 to perform the method in embodiments of the disclosure.

In an implementation, the communication device 1100 can further include a memory 1120. The processor 1110 is configured to invoke and execute computer programs stored in the memory 1120 to cause the communication device 1100 to perform the method in embodiments of the disclosure.

The memory 1120 may be a separate device independent of the processor 1110, or may be integrated in the processor 1110.

In an implementation, the communication device 1100 can further include a transceiver 1130. The processor 1110 can control the transceiver 1130 to communicate with other devices. Specifically, the transceiver 1130 can transmit information or data to other devices, or receive information or data transmitted by other devices.

The transceiver 1130 may include a transmitter and a receiver. The transceiver 1130 may further include one or more antennas.

In an implementation, the communication device 1100 may be the first terminal in the embodiments of the disclosure, and the communication device 1100 can implement the corresponding process implemented by the first terminal in various methods according to embodiments of the disclosure, which will not be repeated herein for the sake of simplicity.

In an implementation, the communication device 1100 may be the serving device in the embodiments of the disclosure, and the communication device 1100 can implement the corresponding process implemented by the serving device in various methods according to embodiments of the disclosure, which will not be repeated herein for the sake of simplicity.

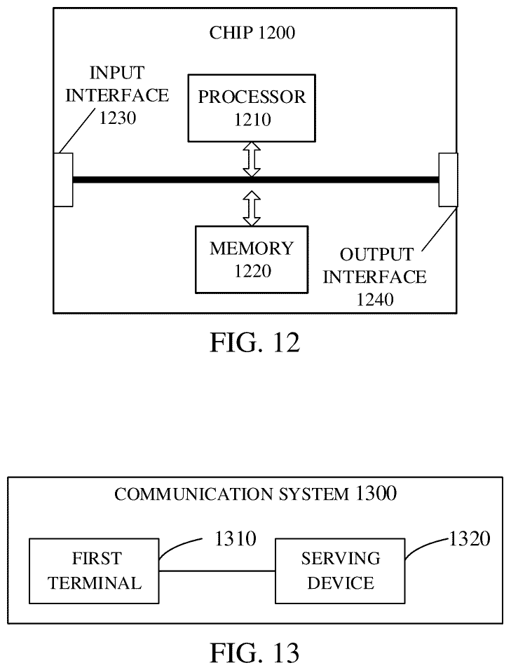

FIG. 12 is a schematic structural diagram of a chip 1200 according to embodiments of the disclosure. The chip 1200 includes a processor 1210. The processor 1210 is configured to invoke and execute computer programs stored in a memory to perform the method in embodiments of the disclosure.

In an implementation, the chip 1200 may further include a memory 1220. The processor 1210 is configured to invoke and execute computer programs stored in the memory 1220 to perform the method performed by the terminal device in embodiments of the disclosure.

The memory 1220 may be a separate device independent of the processor 1210, or may be integrated in the processor 1210.

In an implementation, the chip 1200 may further include an input interface 1230. The processor 1210 can control the input interface 1230 to communicate with other devices or chips. Specifically, the input interface 1230 can obtain information or data transmitted by other devices or chips.

In an implementation, the chip 1200 may further include an output interface 1240. The processor 1210 can control the output interface 1240 to communicate with other devices or chips. Specifically, the output interface 1240 can output information or data to other devices or chips.

In an implementation, the chip can be applied to the first terminal in the embodiments of the disclosure, and the chip can implement the corresponding process implemented by the first terminal in various methods according to embodiments of the disclosure, which will not be repeated herein for the sake of simplicity.

In an implementation, the chip can be applied to the serving device in the embodiments of the disclosure, and the chip can implement the corresponding process implemented by the serving device in various methods according to embodiments of the disclosure, which will not be repeated herein for the sake of simplicity.

It can be understood that, the chip mentioned in the embodiments of the disclosure may also be referred to as a system-level chip, a system chip, a chip system, a system-on-a-chip chip, or the like.

The processor mentioned above may be a general-purpose processor, a digital signal processor (DSP), a field programmable gate array (FPGA), an application specific integrated circuit (ASIC), or other programmable logic devices, transistor logic devices, discrete hardware components, etc. The general-purpose processor may be a microprocessor, or may also be any conventional processor, or the like.

The memory mentioned above may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It can be understood that, the memory mentioned above is an example rather than limitation. For example, the memory may be a static RAM (SRAM), a dynamic RAM (DRAM), a synchronous DRAM (SDRAM), a double data rate SDRAM (DDRSDRAM), an enhanced SDRAM (ESDRAM), a synclink DRAM (SLDRAM), and a direct rambus RAM (DRRAM). That is, the memory in embodiments of the disclosure is intended to include, but is not limited to, these and any other suitable types of memory.

FIG. 13 is a schematic structural diagram of a communication system 1300 according to embodiments of the disclosure. The communication system 1300 includes a first terminal 1310 and a serving device 1320. The first terminal 1310 is configured to perform the method performed by the first terminal in any of the above method embodiments. The serving device 1320 is configured to perform the method performed by the serving device in any of the above method embodiments.

All or part of the above embodiments can be implemented through software, hardware, firmware, or any other combination thereof. When implemented by software, all or part of the above embodiments can be implemented in a form of a computer program product. The computer program product includes one or more computer instructions. When the computer program instructions are loaded and executed on a computer, all or part of the processes or functions of the embodiments of the disclosure are performed. The computer may be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instructions can be transmitted from one website, computer, server, or data center to another website, computer, server, or data center in a wired manner or in a wireless manner. Examples of the wired manner may be, for example, a coaxial cable, an optical fiber, a digital subscriber line (DSL), etc. The wireless manner may be, for example, infrared, wireless, microwave, etc. The computer-readable storage medium may be any computer accessible usable-medium or a data storage device such as a server, a data center, or the like which is integrated with one or more usable media. The usable medium may be a magnetic medium (such as a soft disc, a hard disc, or a magnetic tape), an optical medium (such as a digital video disc (DVD)), or a semiconductor medium (such as a solid state disk (SSD)), etc.

It can be understood that, in various embodiments of the disclosure, the magnitude of a sequence number of each process does not mean an order of execution, and the order of execution of each process may be determined by its function and an internal logic and shall not constitute any limitation to an embodiment process in embodiments of the disclosure.

It will be evident to those skilled in the art that, for the sake of convenience and simplicity, for the specific working processes of the foregoing systems, apparatuses, and units, reference can be made to the corresponding processes in the foregoing method embodiments, which will not be repeated herein.

The above are merely specific embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure should be stated in the scope of protection of the claims.

What is claimed is:

1. A measurement method, comprising:
performing, by a first terminal, processing regarding measurement of an adjacent link when measurement information of a serving link meets a first criterion, wherein the serving link is a link between the first terminal and a serving device, the adjacent link is a link between the first terminal and an adjacent device, and the serving device and/or the adjacent device is a relay terminal.

2. The method of claim 1, wherein the serving device is a serving relay terminal between the first terminal and a second terminal, and the adjacent device is another relay terminal between the first terminal and the second terminal.

3. The method of claim 1, wherein the serving device is a serving relay terminal between the first terminal and a network device of a serving cell where the first terminal is located, and the adjacent device is a network device of a neighboring cell of the serving cell where the first terminal is located.

4. The method of claim 1, wherein the serving device is a network device of a serving cell where the first terminal is located, and the adjacent device is a relay terminal corresponding to the first terminal.

5. The method of claim 1, wherein performing processing regarding the measurement of the adjacent link comprises one of:
disabling the measurement of the adjacent link;
relaxing the measurement of the adjacent link; or
transmitting first reporting information, wherein the first reporting information is used for a network device to determine whether to adjust the measurement of the adjacent link.

6. The method of claim 1, wherein the first criterion is preconfigured, configured by a network device, or configured by the serving device.

7. The method of claim 1, further comprising:
receiving, by the first terminal, first indication information, wherein the first indication information is used to determine the first criterion.

8. The method of claim 7, wherein the first indication information indicates a transmission power class of the serving device.

9. The method of claim 8, further comprising:
determining, by the first terminal, the first criterion based on the transmission power class of the serving device and at least one criterion.

10. The method of claim 9, wherein determining, by the first terminal, the first criterion based on the transmission power class of the serving device and the at least one criterion comprises:
selecting, by the first terminal, the first criterion from the at least one criterion based on the transmission power class of the serving device.

11. The method of claim 9, wherein determining, by the first terminal, the first criterion based on the transmission power class of the serving device and the at least one criterion comprises:
processing, by the first terminal, a second criterion among the at least one criterion based on the transmission power class of the serving device to obtain the first criterion.

12. The method of claim 9, wherein the at least one criterion is preconfigured, configured by a network device, or configured by the serving device.

13. The method of claim 12, wherein a parameter in the at least one criterion comprises a threshold, the threshold is related to the measurement information, and the threshold is preconfigured, configured by a network device, or configured by the serving device, wherein the measurement information comprises a reference signal receiving power (RSRP) and/or a reference signal receiving quality (RSRQ).

14. The method of claim 9, further comprising:
receiving, by the first terminal, second indication information, wherein the second indication information indicates a correspondence between at least one transmission power class and the at least one criterion.

15. The method of claim 9, further comprising:
determining, by the first terminal, a correspondence between at least one transmission power class and the at least one criterion based on a threshold in the at least one criterion, wherein determining, by the first terminal, the correspondence between the at least one transmission power class and the at least one criterion based on the threshold in the at least one criterion comprises:
determining, by the first terminal, the correspondence between the at least one transmission power class and the at least one criterion based on an order of magnitude of the threshold in the at least one criterion and an order of magnitude of the at least one transmission power class.

16. The method of claim 7, wherein the first indication information indicates the first criterion, and the first criterion is determined by the serving device.

17. The method of claim 7, wherein the first indication information is carried by at least one of: a Uu interface signaling, a sidelink (SL) signaling, an SL radio resource control (RRC) signaling, or an SL discovery message.

18. The method of claim 1, wherein the first criterion comprises at least one of:
a not-at-cell-edge criterion;
a stationary criterion; or
a low mobility criterion.

19. A measurement method, comprising:
transmitting, by a serving device, first indication information to a first terminal, wherein the first indication information is used for the first terminal to determine a first criterion so as to perform processing regarding measurement of an adjacent link when measurement information of a serving link meets the first criterion, the serving link is a link between the first terminal and the serving device, the adjacent link is a link between the first terminal and an adjacent device, and the serving device and/or the adjacent device is a relay terminal.

20. A first terminal, comprising:
a memory configured to store computer programs; and
a processor configured to invoke and execute the computer programs stored in the memory, to cause the first terminal to:
perform processing regarding measurement of an adjacent link when measurement information of a serving link meets a first criterion, wherein the serving link is a link between the first terminal and a serving device, the adjacent link is a link between the first terminal and an adjacent device, and the serving device and/or the adjacent device is a relay terminal.
